(19) United States
(12) Patent Application Publication
(10) Pub. No.: US 2015/0144501 A1
(43) Pub. Date: May 28, 2015

(54) Method and Apparatus for Conditioning Hydrogen

(71) Applicant: Robert Bosch GmbH, Stuttgart (DE)

(72) Inventors: Annika Utz, Stuttgart (DE); Kai Weeber, Heimsheim (DE); Dietmar Steiner, Welzheim (DE)

(21) Appl. No.: 14/540,437

(22) Filed: Nov. 13, 2014

(30) Foreign Application Priority Data
Nov. 26, 2013 (DE) 10 2013 224 062.7

(51) Int. Cl. H01M 8/04; C25B 1/10

(52) U.S. Cl. CPC H01M 8/04089; C25B 1/10
USPC 205/628; 204/252

(57) ABSTRACT

A method for conditioning hydrogen includes positioning hydrogen on a suction side of an electrochemical compressor. The hydrogen includes at most a fractional amount of an extraneous species. The electrochemical compressor includes a first electrode on a suction side and a second electrode on a pressure side and is configured to apply an electrical potential between the first and second electrodes. The method further includes transporting ions of the hydrogen through a membrane of the electrochemical compressor via the electrical potential in order to increase a hydrogen partial pressure on the pressure side of the electrochemical compressor and such that the extraneous species remains on the suction side of the electrochemical compressor.

This application claims priority under 35 U.S.C. §119 to patent application Ser. No. DE 10 2013 224 062.7, filed on Nov. 26, 2013 in Germany, the disclosure of which is incorporated herein by reference in its entirety.

The present disclosure pertains to a method for conditioning hydrogen, to a corresponding apparatus, and also to a corresponding computer program product.

### BACKGROUND

In the production of hydrogen by electrolysis of water, the hydrogen has a process-related water fraction in the form of water vapor. In order to prepare the hydrogen for further use, the water vapor can be removed from the hydrogen.

DE 36 50 465 T2 describes a permeable polymer membrane for gas drying.

### SUMMARY

Against this background, with the approach presented here, a method for conditioning hydrogen, an apparatus for conditioning hydrogen and also, lastly, a corresponding computer program product are presented. Advantageous embodiments are apparent from the respective claims and from the description hereinafter.

For hydrogen to be stored industrially, the hydrogen must be compressed. The compression may take place mechanically via a compressor. In a mechanical compressor and also in a pressure tank, water is a disruptive factor, whether in liquid, solid or gaseous phase. Consequently, the hydrogen is dried prior to mechanical compression.

A method for conditioning hydrogen is presented, the method featuring the following steps:

providing the hydrogen on a suction side of an electrochemical compressor, it being possible for the hydrogen to be provided with a fraction of extraneous species; and

transporting ions of the hydrogen through a membrane of the compressor using an electrical potential which is applied between a suction-side first electrode of the compressor and a pressure-side second electrode of the compressor, in order to increase a hydrogen partial pressure on a pressure side of the compressor and to leave the extraneous species on the suction side of the compressor.

Additionally presented is an apparatus for conditioning hydrogen, the apparatus having the following features:

an electrochemical compressor with a membrane, with a suction-side first electrode and with a pressure-side second electrode, it being possible for an electrical potential to be applied between the first electrode and the second electrode in order to transport ions of the hydrogen from a suction side of the compressor to a pressure side of the compressor, to increase a hydrogen partial pressure on the pressure side and to leave extraneous species on the suction side; and

a device for providing the hydrogen on the suction side, it being possible for the hydrogen to be provided with a fraction of extraneous species.

This variant embodiment of the disclosure as well, in the form of an apparatus, allows the problem addressed by the disclosure to be solved rapidly and efficiently.

Hydrogen can be compressed electrochemically. The hydrogen in that case can be transported in the form of ions through a membrane. For this purpose, the hydrogen can be split catalytically on a suction side of the membrane into ions and electrons. The electrons can be taken off by an electrical potential. The ions are able to migrate through the membrane. As a result of the electrical potential, the electrons can be provided again on a pressure side of the membrane, where the ions are able to recombine catalytically with the electrons to form hydrogen. On account of the electrical potential that is applied, an equilibrium of the ions on the suction side and the ions on the pressure side is shifted in favor of the pressure side. On a net basis, more ions migrate from the suction side to the pressure side, as a result of the electrical potential, than vice versa.

Since exclusively hydrogen ions are transported through the membrane, the water vapor is left remaining on the suction side. The water vapor is able to condense on the membrane and moisten the membrane for improved function.

An electrochemical compressor has a high efficiency which is reduced only by ohmic losses. Warming of the hydrogen during compression is insubstantial. The electrochemical compressor is free from moving parts, and so there is virtually no wear. The electrochemical compressor is also quiet and does not propagate vibrations.

Conditioning can be understood as an alteration of properties. In this case, the properties are altered in line with set requirements. In particular, a pressure of the hydrogen and a purity of the hydrogen are adapted. An extraneous species may be, in particular, water. The water may be present in a gas phase, in other words in vapor form. The extraneous species may also be a gas other than hydrogen. A suction side can be understood as a side of the apparatus that draws. A pressure side can be understood as a side of the apparatus that repels. The suction-side electrode and the pressure-side electrode may be arranged directly on the membrane. The membrane ought to be electrically insulating. The membrane may be catalytically treated. The membrane ought to be permeable to hydrogen ions.

The hydrogen can be provided using electrical energy. Here, water can be split into hydrogen and oxygen. The extraneous species may be, in particular, water vapor. Through a direct connection in a unit, the hydrogen can be produced in a confined space and compressed. Overall, through the integration of electrolysis and conditioning in a system, the system complexity is significantly reduced.

The hydrogen can be transported with a predetermined pressure and, alternatively or additionally, with a predetermined temperature and, alternatively or additionally, with a predetermined purity to the pressure side. For motor vehicle applications, for example, a pressure in the range from greater than or equal to 30 bar to less than or equal to 800 bar and room temperature would be conceivable. The hydrogen ought preferably to have a purity of 5.0 Hz (corresponding to 99.999% Hz). Through the electrical potential, the pressure on the suction side can be adjusted. After transport through the membrane, the hydrogen can be cooled or heated in order to achieve desired properties. As a result of the conditioning, the hydrogen can meet predetermined criteria.

In the transporting step, a direct voltage can be applied to the electrodes. The direct voltage may be smoothed. As a result of a direct voltage, the hydrogen can be transported uniformly.

The ions may be transported quasi-isothermally through the membrane. In that case the ions may be transported without notable warming. Without warming, transport can take place with a high efficiency.

The method may feature a step of storing the hydrogen on the pressure side in a pressure accumulator. A large quantity of hydrogen can be stored in a pressure accumulator or pressure tank.

The device for providing may be designed as an electrolyzer. The electrolyzer can split water into hydrogen and oxygen, using electrical energy. The extraneous species may be, in particular, water vapor. The device for providing may be connected in series, electrically and hydrogen-fluidically, with the electrochemical compressor. The amount of hydrogen produced may be proportional to an amount of energy used for the electrolysis. The amount of hydrogen transported through the membrane may be proportional to an amount of energy used for the transporting. The electrolysis may therefore be coupled electrically to the transporting.

The compressor may have at least one further membrane with a further suction-side first electrode and a further pressure-side second electrode. The membrane and the further membrane may be arranged in series and may be designed to increase the hydrogen partial pressure from the suction side to the pressure side in steps. As a result of a plurality of membranes connected in series, the hydrogen can be provided with a higher pressure. It is also possible for a reduced pressure gradient to be set between the suction side of a membrane and the pressure side of the membrane. As a result, the individual membranes can be made thinner and the transporting of the hydrogen can be more dynamic.

The membrane may be designed as a polymer electrolyte membrane. A polymer electrolyte membrane can be produced with a particularly even thickness.

The membrane may have a drain for carrying off the extraneous species. Condensing water can be carried off from the membrane through the drain. As a result, an active area of the membrane can be kept large.

The apparatus may have a pressure accumulator for storing the hydrogen on the pressure side. A pressure accumulator allows the apparatus to be provided as a complete system.

Also of advantage is a computer program product with program code which can be stored on a machine-readable medium such as a semiconductor memory, a hard disk memory or an optical memory, and which is used to implement the method according to one of the above-described embodiments when the program product is implemented on a computer or an apparatus.

### BRIEF DESCRIPTION OF THE DRAWINGS

The approach presented here is elucidated in more detail below, by way of example, with reference to the attached drawings, in which:

FIG. 1 shows a block diagram of an apparatus for conditioning hydrogen according to one working example of the present disclosure;

FIG. 2 shows a flow diagram of a method for conditioning hydrogen using an electrochemical compressor as combined gas drying unit and compression unit within an electrolysis system, according to one working example of the present disclosure; and

FIG. 3 shows a process diagram of a method for conditioning hydrogen according to one working example of the present disclosure.

### DETAILED DESCRIPTION

In the description below of advantageous working examples of the present disclosure, identical or similar reference symbols are used for the elements with similar effect that are shown in the various figures; a description of these elements is not repeated.

An electrolysis system consists customarily of a water preparation facility, a (direct) voltage source, an electrolysis stack, a gas purifying and/or gas drying facility, a compressor and a (high-pressure) gas accumulator.

For the gas drying facility, a condensation procedure (“gas-chiller”), a zeolite-based adsorption filter or a pressure swing adsorption (PSA) may be used. With a pure condensation procedure, the required quality of gas at low pressures of one to 30 bar is not possible, since the dew point is situated at one bar at minus 60° C. Adsorption filters are sensible only for plants with a small production volume, or require exchange for the regeneration of the adsorbent; this may adversely affect the sealing of the plant. A PSA, on the other hand, is sensible only with large plants, but leads to a considerable loss of ten to 30% of the product gas, resulting from the need to flush the operating chambers in order to regenerate the reactor bed.

For the compression, mechanical compressors can be employed. In order to prevent the hydrogen being contaminated by lubricating oil, unlubricated compressors may be used, which have a short lifetime and/or short maintenance intervals. It is also possible for ionic compressors to be employed, which allow a longer running time. These compressors, however, have a very large footprint.

The saturation water content of a gas is dependent directly on temperature and pressure of the gas. As the pressure goes up, the dew point rises for a specified water vapor concentration. The quality of hydrogen that is usually required for fuel cell applications, of 99.999% H2, has a dew point of around four degrees Celsius at 800 bar. This means that the required quality of gas can be achieved even on compression to 800 bar or more with, optionally, subsequent cooling of the gas. Here, an electrochemical compressor, as presented here, has the advantage that residual moisture in the hydrogen does not lead to the destruction of the compressor, but in fact, on the contrary, maintains or improves the proton conductivity of the membrane.

This effect of reducing the water content of the hydrogen through pressure increase is utilized in the electrochemical compressor presented here, with the gas being compressed to the required pressure in one or more stages and the required purity being directly met without additional gas drying.

The table below shows the dew point for water over ice for 5.0 H₂.

| Pᵢ | P_{abs} @0.01% H₂O | T_sat |
|---|---|---|
| [bar] | [bar] | [° C.] |
| 0.00001 | 1 | −60 |
| 0.0001 | 10 | −42 |
| 0.001 | 100 | −20 |
| 0.008 | 800 | +4 |
| 0.01 | 1000 | +7 |

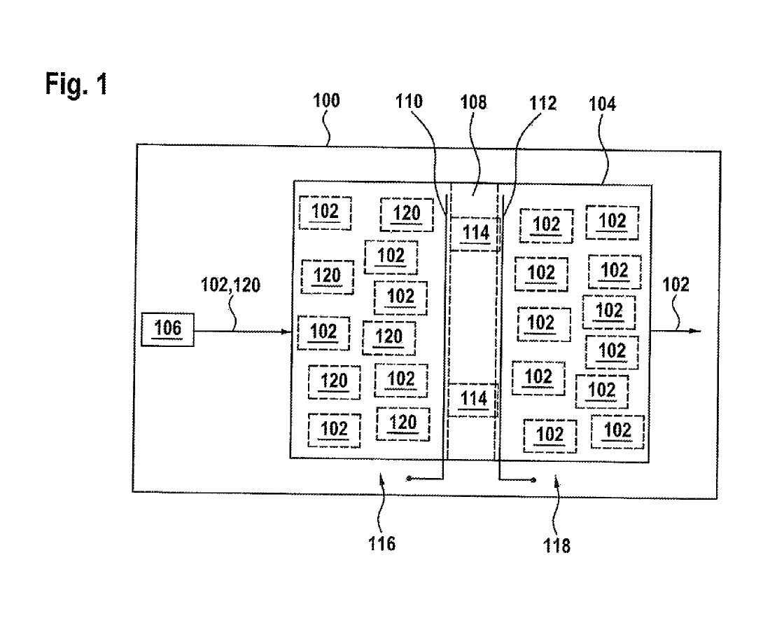

FIG. 1 shows a block diagram of an apparatus 100 for conditioning hydrogen 102 according to one working example of the present disclosure. The apparatus 100 has an electrochemical compressor 104 and a device 106 for the providing. The electrochemical compressor 104 has a membrane 108, a suction-side first electrode 110 and a pressure-side second electrode 112. An electrical potential can be applied between the first electrode 110 and the second electrode 112 in order to transport ions 114 of the hydrogen 102 from a suction side 116 of the compressor 104 to a pressure side 118 of the compressor 104, to increase a hydrogen partial pressure on the pressure side 118 and to leave extraneous species 120 on the suction side 116. The device 106 for providing is designed to provide the hydrogen 102 on the suction side 116. It is possible to provide the hydrogen 102 with a fraction of extraneous species 120.

In one working example, the compressor 104 has at least one further membrane with a further suction-side first electrode and a further pressure-side second electrode. The membrane and the further membrane are arranged in series and are designed to increase the hydrogen partial pressure from the suction side to the pressure side in steps. Arranged between the membranes 108 is a chamber into which one membrane transports the hydrogen and from which the other membrane transports it out again.

In one working example, the membrane 108 is designed as a polymer electrolyte membrane 108.

In one working example, the membrane 108 has a drain for carrying off the extraneous species. The drain is arranged on the suction side and is designed to carry the extraneous species from the apparatus 100.

In one working example, the electrochemical compressor 104 is supplied, without an upstream gas drying facility, directly with the hydrogen 102 from an electrolysis stack 106. At the outlet of the electrochemical compressor 104, the hydrogen 102, depending on the pressure stage selected, directly meets the requirements of the downstream systems, such as a gas accumulator or a fuel cell, for example. The required dryness of the gas can be improved by additional moderate cooling of the gas.

In one working example, the electrolysis stack 106 is operated directly in differential pressure operation. Accordingly, H₂ production, drying and compression are carried out in one component.

The membrane 108 of the electrochemical cell 104 does not require additional supply of water, since this supply is ensured simply via the residual moisture 120 in the hydrogen 102.

In one working example, a water take-off facility is integrated in the membrane 108.

In one working example, the target pressure is attained in one stage.

In one working example, the target pressure is attained in a plurality of pressure stages by connection of a plurality of electrochemical cells 104 in series. In this case, compression of hydrogen 102 from 1 bar to 1000 bar in one step is technically feasible.

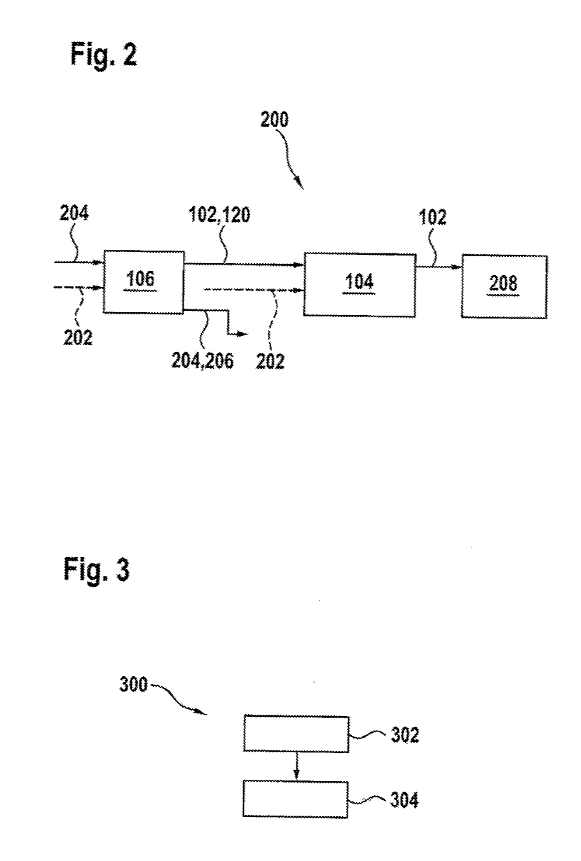

FIG. 2 shows a flow diagram of a method for conditioning hydrogen H₂ 102 using an electrochemical compressor 104 as combined gas drying unit and compression unit within an electrolysis system 200 according to one working example of the present disclosure. The device 106 here for providing is an electrolyzer 106 or an electrolysis stack 106, and is designed to split water H₂O 204 into hydrogen H₂ 102 and oxygen O₂ 206 using electrical energy 202. As part of the operation, water vapor H₂O 120 is admixed as extraneous species 120 to the hydrogen H₂ 102. The compressed and purified hydrogen H₂ 102 is stored on the pressure side in a pressure accumulator 208. The electrical energy 202 here is provided as direct voltage.

With the approach presented here, there is no need for the separate gas drying upstream of the compressor that is absolutely necessary in the case of mechanical compressors. This makes it possible to reduce the complexity of the system significantly. As a result, the electrolysis system 200 presented here can be implemented with a reduced construction volume, a reduced noise level and extended maintenance intervals by comparison with a mechanical system.

In other words, FIG. 2 shows an electrolysis system 200 with electrochemical cell 104 for the compression and drying of hydrogen 102.

Hydrogen electrolyzers 106 and/or electrolysis systems 200 serve to produce hydrogen from water 204 and current 202, and find application, for example, in hydrogen filling points for fuel cell vehicles or power-to-gas applications. Fuel cell vehicles have particularly high requirements with regard to the purity and particularly the water content of the hydrogen 102 produced. Normally a purity of 5.0 H₂ (corresponding to 99.999% H₂) is required. The reasoning lies firstly in the sensitivity of the fuel cell catalyst to impurities, and secondly in a possible condensation of water 120 at low temperatures and/or high pressures, a phenomenon which can lead to pressure fluctuations in the gas supply or to freezing of the pipelines.

Gas drying of the electrolytically produced hydrogen 102 is necessary, since as a result of the operation, the hydrogen 102 at the outlet of the electrolysis stack 106 has a certain moisture content 120. This moisture content 120 would lead to water hammer during compression in a mechanical compressor, and hence to the destruction of the mechanical compressor.

With the approach presented here, the compression of the hydrogen 102 takes place in an electrochemical cell 104 or in an electrochemical compressor 104. In contrast to mechanical compressors, the electrochemical compressor 104 takes on moisture management as well as the compression of the hydrogen 102, at the same time, and so removes the need for additional, upstream gas drying. The complexity of the system is significantly reduced accordingly.

The principal advantage of the approach presented here lies in a reduced complexity of the system, since there is no need for an additional component for the gas drying, as a result of the use of an electrochemical compressor 104. One of the consequences of this is a space saving for the overall system 200, and an improvement in the system efficiency can additionally be achieved.

As a result of the compression of the gas 102 without moving parts, the operation of the system 200 is more noise-reduced and less maintenance-intensive.

The hydrogen 102 is compressed using an electrochemical compressor 104, based for example on a polymer electrolyte membrane PEM. Application of a direct current voltage 204 to the electrodes of the electrochemical cell 104 results in an H+ flow from one side of the membrane to the other, and hence to an increase in pressure. The pressure increase attained is dependent on the voltage applied.

U=RT/2F In(p₂/p₁)+ir+η

U here is the applied voltage, R the gas constant, T the temperature, F the Faraday constant, p₁ the pressure in the first gas space, p₂ the pressure in the second gas space, i the current density, r the resistance of the electrochemical cell 104, and η the overvoltage.

Owing to a quasi-isothermal compression of the gas 102, the efficiency of the electrochemical compression is very good, particularly in comparison to the adiabatic compression of a mechanical compressor.

FIG. 3 shows a process diagram of a method 300 for conditioning hydrogen according to one working example of the present disclosure. The method 300 features a step 302 of providing and a step 304 of transporting. In the providing step 302, the hydrogen is provided on a suction side of an electrochemical compressor. The hydrogen here can be provided in pure form and also with a fraction of extraneous species. In the transporting step 304, ions of the hydrogen are transported through a membrane of the compressor, using an electrical potential. The potential is applied between a suction-side first electrode of the compressor and a pressure-side second electrode of the compressor. The transporting increases a hydrogen partial pressure on a pressure side of the compressor. The extraneous species is left behind on the suction side of the compressor.

In one working example, in the providing step 302, the hydrogen is provided using electrical energy. For this purpose, water is split into hydrogen and oxygen. The extraneous species in this case is, in particular, water vapor. The amount of water vapor in the hydrogen is in equilibrium with a gas pressure of the hydrogen on the suction side.

In one working example, in the transporting step 304, the hydrogen is transported to the pressure side with a predetermined pressure and/or a predetermined temperature and/or a predetermined purity. It is possible to predetermine the pressure established on the pressure side, via the electrical potential. In order to regulate the temperature, a heating element and/or a cooling element may be arranged on the pressure side.

In one working example, in the transporting step 304, a direct voltage is applied to the electrodes.

In one working example, in the transporting step 304, the ions are transported quasi-isothermally through the membrane. As a result of the electrical potential there is essentially no change in temperature from the suction side to the pressure side. There is therefore an absence of the energy demand which, in the case of mechanical compression, enters merely into the unwanted change of temperature.

In one working example, the method 300 has a step of storing. In the storing step, the hydrogen is stored in a pressure accumulator on the pressure side.

The working examples that have been described and shown in the figures are selected only by way of example. Different working examples may be combined with one another fully or in respect of individual features. Additionally, one working example may be supplemented by features from another working example.

Furthermore, the method steps presented here may be implemented repeatedly and also in a sequence other than that described.

Where a working example comprises an “and/or” conjunction between a first feature and a second feature, this should be read to mean that according to one embodiment, the working example has both the first feature and the second feature, and according to another embodiment it has either only the first feature or only the second feature.

What is claimed is:

1. A method for conditioning hydrogen, comprising:
positioning hydrogen on a suction side of an electrochemical compressor that includes a first electrode on a suction side of the electrochemical compressor, a second electrode on a pressure side of the electrochemical compressor, and a membrane positioned between the first and second electrodes, wherein:
the hydrogen includes at most a fractional amount of an extraneous species; and
the electrochemical compressor is configured to generate an electrical potential between the first and second electrodes; and
transporting ions of the hydrogen through the membrane via the electrical potential in order to increase a hydrogen partial pressure on the pressure side of the electrochemical compressor, such that the extraneous species remains on the suction side of the electrochemical compressor.

2. The method according to claim 1, wherein:
the hydrogen is positioned on the suction side of the electrochemical compressor by using electrical energy to split water into hydrogen and oxygen; and
the extraneous species is water vapor.

3. The method according to claim 1, wherein transporting the hydrogen ions includes producing at least one of (i) a predetermined pressure, (ii) a predetermined temperature, and (iii) a predetermined purity of hydrogen on the pressure side of the electrochemical compressor.

4. The method according to claim 1, wherein transporting the hydrogen ions includes applying a direct voltage to the first and second electrodes.

5. The method according to claim 1, wherein the transportation of the hydrogen ions through the membrane is quasi-isothermal.

6. The method according to claim 1, further comprising storing hydrogen produced on the pressure side of the electrochemical compressor in a pressure accumulator.

7. An apparatus for conditioning hydrogen, comprising:
an electrochemical compressor that includes:
a first electrode on a suction side of the electrochemical compressor;
a second electrode on a pressure side of the electrochemical compressor; and
a membrane positioned between the first and second electrodes;
wherein the electrochemical compressor is configured to generate an electrical potential between the first and second electrodes such that:
hydrogen ions from hydrogen positioned at the suction side of the electrochemical compressor are transported through the membrane to the pressure side of the electrochemical compressor in order to increase a hydrogen partial pressure on the pressure side of the electrochemical compressor; and
an extraneous species remains on the suction side of the electrochemical compressor; and
a device configured to position hydrogen on the suction side of the electrochemical compressor, wherein the hydrogen includes at most a fractional amount of the extraneous species.

8. The apparatus according to claim 7, wherein:
the device is an electrolyzer configured to split water into hydrogen and oxygen using electrical energy; and
the extraneous species is water vapor.

9. The apparatus according to claim 7, wherein:
the electrochemical compressor further includes at least one further membrane having a further first electrode on a suction side and a further second electrode on a pressure side; and
the at least one further membrane is arranged in series with the first electrode, the membrane, and the second electrode, and is configured to increase the hydrogen partial pressure in steps from the suction side of the electrochemical compressor to the pressure side of the electrochemical compressor.

10. The apparatus according to claim 7, wherein the membrane includes a polymer electrolyte.

11. The apparatus according to claim 7, wherein the membrane includes a drain configured to carry out the extraneous species.

12. The apparatus according to claim 7, further comprising a pressure accumulator configured to store hydrogen produced on the pressure side of the electrochemical compressor.
